(19) United States
(12) Patent Application Publication
(10) Pub. No.: US 2026/0243629 A1
(43) Pub. Date: Aug. 20, 2026

(54) ENGINE DIAGNOSIS SYSTEM AND ENGINE DIAGNOSIS METHOD

(71) Applicant: KOMATSU LTD., Tokyo (JP)

(72) Inventors: Yoshitoshi Nagado, Tokyo (JP); Yuuki Muranaka, Tokyo (JP); Sho Takeuchi, Tokyo (JP); Keisuke Takahata, Tokyo (JP)

(73) Assignee: KOMATSU LTD., Tokyo (JP)

(21) Appl. No.: 19/160,740

(22) PCT Filed: Mar. 6, 2023
(86) PCT No.: PCT/JP2023/008335

§ 371 Date: Aug. 28, 2025

(51) Int. Cl. G01M 15/05; F02D 41/22

(52) U.S. Cl. CPC G01M 15/05; F02D 41/22

(57) ABSTRACT

This engine diagnosis system is an engine diagnosis system for diagnosing a state of an engine included in a vehicle in accordance with an operating state of the engine and includes a data acquisition unit configured to acquire a detection value related to a parameter indicating the operating state of the engine a plurality of times at time intervals, a diagnosis unit configured to diagnose the state of the engine based on the detection value acquired by the data acquisition unit; and a result output unit configured to output a diagnosis result in the diagnosis unit, in which the diagnosis unit includes a determination unit configured to determine whether or not a failure has occurred in the engine based on a moving average of a plurality of the detection values acquired at time intervals and the latest detection value acquired by the data acquisition unit.

### TECHNICAL FIELD

The present invention relates to an engine diagnosis system and an engine diagnosis method.

### BACKGROUND ART

In order to take measures (maintenance) in accordance with a failure or deterioration of a vehicle, an appropriate measure method is often determined by actually observing a state of the vehicle. However, such a method requires an operator to have specialized knowledge or experience. Further, it takes time and effort to find an appropriate measure method. Therefore, a system capable of automatically diagnosing a state of a vehicle has been provided.

For example, Patent Document 1 discloses a configuration in which time-series data of knock learning values of engines are acquired from a plurality of vehicles of the same type and accumulated, and an evaluation value of a degree of deterioration of an engine that is a diagnosis target is calculated based on the accumulated time-series data, thereby diagnosing the degree of deterioration of the engine.

### CITATION LIST

### Patent Literature

Patent Document 1: Japanese Patent No. 6741119

### SUMMARY OF INVENTION

### Technical Problem

In the configuration disclosed in Patent Document 1 as described above, the degree of deterioration of the engine that is a diagnosis target is evaluated based on the time-series data acquired from the plurality of vehicles of the same type. However, even in the same type of vehicle, an occurrence situation of a failure in each vehicle may differ depending on a use state of the vehicle or the like.

The present disclosure has been made in view of the above circumstances, and an object thereof is to provide an engine diagnosis system and an engine diagnosis method capable of more appropriately diagnosing a failure in each vehicle.

### Solution to Problem

In order to solve the problem, according to an aspect of the present disclosure, there is provided an engine diagnosis system for diagnosing a state of an engine included in a vehicle in accordance with an operating state of the engine, the engine diagnosis system including: a data acquisition unit configured to acquire a detection value related to a parameter indicating the operating state of the engine a plurality of times at time intervals; a diagnosis unit configured to diagnose the state of the engine based on the detection value acquired by the data acquisition unit; and a result output unit configured to output a diagnosis result in the diagnosis unit, in which the diagnosis unit includes a determination unit configured to determine whether or not a failure has occurred in the engine based on a moving average of a plurality of the detection values acquired at time intervals and the latest detection value acquired by the data acquisition unit.

### Advantageous Effects of Invention

According to each aspect of the present disclosure, it is possible to more appropriately diagnose a failure in each vehicle.

### BRIEF DESCRIPTION OF DRAWINGS

FIG. 1 is a schematic configuration diagram of an engine diagnosis system according to an embodiment.

FIG. 2 is a diagram illustrating an example of a correlation diagram between an engine speed and a torque when a plurality of detection values are detected in the engine diagnosis system according to the embodiment.

FIG. 3 is a diagram illustrating an example of time-series data obtained from a plurality of detection values in the engine diagnosis system according to the embodiment.

FIG. 4 is a diagram illustrating an example of a prediction model of a parameter that leads to a failure due to deterioration or wear over time in the engine diagnosis system according to the embodiment.

FIG. 5 is a diagram illustrating an example of abnormality determination content of each parameter based on the presence or absence of an accidental abnormality and the presence or absence of a deterioration abnormality in the engine diagnosis system according to the embodiment.

FIG. 6 is a diagram illustrating an example of determination content when a failure determination is made by using a specific parameter or a combination of a plurality of parameters as a criterion for determining the occurrence of a failure in the engine diagnosis system according to the embodiment.

FIG. 7 is a flowchart showing a flow of an engine diagnosis method according to the embodiment.

FIG. 8 is a diagram illustrating an example of data of a difference between time-series data aggregated into daily data and a moving average of time-series data in an engine diagnosis system according to a variation of the embodiment.

### DESCRIPTION OF EMBODIMENTS

Hereinafter, embodiments of the present disclosure will be described with reference to the drawings. The same or corresponding components in each drawing are denoted by the same reference numerals and description thereof is omitted appropriately.

### (Example of Overall Configuration of Engine Diagnosis System 1)

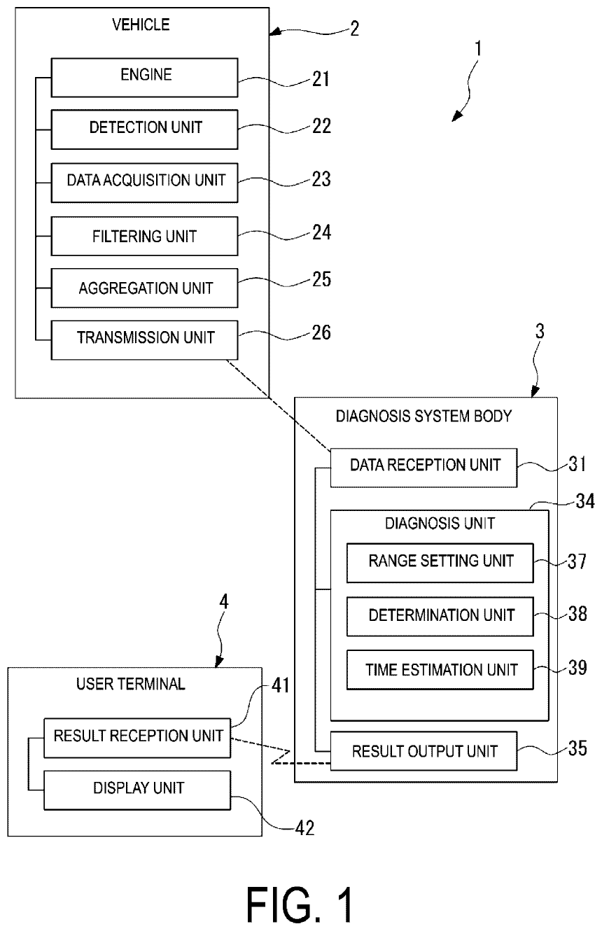

FIG. 1 is a schematic configuration diagram of an engine diagnosis system 1 according to an embodiment.

As illustrated in FIG. 1, in the present embodiment, the engine diagnosis system 1 includes a vehicle 2, a diagnosis system body 3, and a user terminal 4.

### (Configuration Example of Vehicle 2)

A vehicle 2 is a work machine such as a hydraulic excavator, a motor grader, a bulldozer, a wheel loader, or a dump truck. The vehicle 2 is not limited to a work machine, and may be any other vehicle.

The vehicle 2 functionally includes an engine 21, a detection unit 22, a data acquisition unit 23, a filtering unit 24, an aggregation unit 25, and a transmission unit 26.

The engine 21 serves as a drive source for self-propelling of the vehicle 2 and an operation of the work machine included in the vehicle 2. The engine 21 is, for example, a diesel engine or gasoline engine.

The detection unit 22 detects an operating state of each unit of the engine 21. In the present embodiment, the detection unit 22 detects detection values related to a plurality of parameters as an operating state of the engine 21. The detection unit 22 detects detection values related to a plurality of parameters whose states change when some failure, deterioration, wear, or the like occurs in the engine 21.

In the present embodiment, as the operating state of the engine 21, for example, detection values of parameters such as an engine speed, a torque generated in the engine, a temperature of cooling water of the engine, a pressure (boost pressure) or a temperature of an intake manifold, a hydraulic pressure of lubricating oil of the engine, a variable geometry turbo (VGT) position, a diesel oxidation catalyst (DOC) temperature rise efficiency, a pressure in a crankcase of the engine, a temperature of urea water (diesel exhaust fluid (DEF)), a urea water concentration, a torque ratio, a fuel consumption (Fuel Rate), an engine outlet NOx concentration, and a diesel particulate filter (DPF) delta pressure are detected.

The detection unit 22 detects a detection value related to each of a plurality of parameters indicating the operating state of the engine 21 a plurality of times (periodically) at time intervals. Further, when detecting the detection value related to the parameter indicating the operating state of the engine 21, the detection unit 22 associates time information at which each detection value is detected and a type of operation mode selected at each time with the detection value.

The data acquisition unit 23 receives data of the detection value detected by the detection unit 22. Thus, the data acquisition unit 23 acquires the detection value related to each of the plurality of parameters indicating the operating state of the engine 21 and the time information associated with the detection value a plurality of times at time intervals. The data acquisition unit 23 can associate a rotation speed, a torque, a water temperature, and the like of the engine 21 at a time when each detection value is detected with each detection value based on the time information associated with each detection value.

The filtering unit 24 extracts a detection value acquired in an operation state of the engine 21 satisfying a preset condition among a plurality of detection values related to each parameter acquired by the data acquisition unit 23. For example, the filtering unit 24 extracts the detection value acquired in the operation state of the engine 21 satisfying a preset condition based on the rotation speed and the torque of the engine 21, the time change amount (amount of change per unit time) of the rotation speed of the engine 21, the time change amount of the torque, the water temperature of the cooling water of the engine 21, and the like when each detection value is detected.

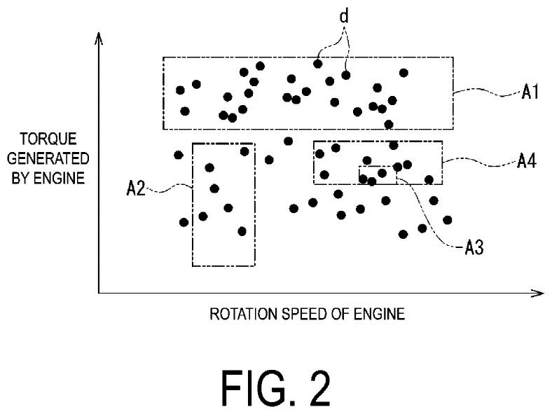

FIG. 2 is a diagram illustrating an example of a correlation diagram between the rotation speed and the torque of the engine 21 when a plurality of detection values are detected in the engine diagnosis system 1 according to the embodiment.

For example, as illustrated in FIG. 2, the filtering unit 24 extracts only detection values d in which the rotation speed and the torque of the engine 21 are within a preset region A, among a plurality of detection values d acquired by the data acquisition unit 23.

Here, the region A is formed to have a preset rotation speed region for the rotation speed of the engine 21 and a preset torque region for the torque of the engine 21. A plurality of such regions A (for example, regions A1 to A4) can be set. Among the plurality of regions A1 to A4, for example, the region A1 is set in accordance with the rotation speed region and the torque region of the engine 21 when the vehicles 2 are normally used. In other words, the region A1 is set in accordance with the rotation speed region and the torque region of the engine 21 in which the number of the detection values d is the largest. Further, for example, the regions A2 and A3 are set in accordance with the rotation speed region and the torque region of the engine 21 used when a specific work is performed. For example, the region A4 is set to be expanded from the region A3 in order to increase the number of detection values d that is an evaluation target when the number of detection values d in the region A3 is small.

The filtering unit 24 illustrated in FIG. 1 extracts, from among the plurality of detection values d acquired by the data acquisition unit 23, the detection values d acquired when the time change amount of the rotation speed and the time change amount of the torque of the engine 21 at the time of detection of the detection value d are within a preset reference value. Here, the time change amount of the rotation speed and the time change amount of the torque of the engine 21 are obtained by calculating a plurality of change amounts of the rotation speed and the torque of the engine 21 when a plurality of detection values d with time information that precedes or follows one another are acquired. For example, when the engine speed is increased or decreased, the reference value is set so that time change amount of the rotation speed and the time change amount of the torque of the engine 21 deviate from the preset reference value. Thus, the detection values d detected when the engine speed is increased or decreased are not extracted by the filtering unit 24. In this way, the evaluation can be performed while avoiding the detection values d detected when the state of the engine 21 is a transient state.

The filtering unit 24 extracts, from the plurality of detection values d acquired by the data acquisition unit 23, the detection values d acquired when a temperature of the cooling water of the engine 21 at the time of detection of the detection value d is equal to or higher than a preset reference temperature. This makes it possible to perform evaluation while avoiding the detection values d detected when the temperature of the cooling water is low and the state of the engine 21 is unstable, such as immediately after the start of the engine 21.

The filtering unit 24 can also classify the detection values d based on the operation mode of the engine 21 when the detection values d are detected. Examples of the operation mode of the engine 21 include a normal operation mode, a highland mode used in a highland where the oxygen concentration is low, a low-temperature mode used when an outside air temperature is low, and a forced regeneration mode used when regenerating a post-processing device that processes substances contained in an exhaust gas from the engine 21.

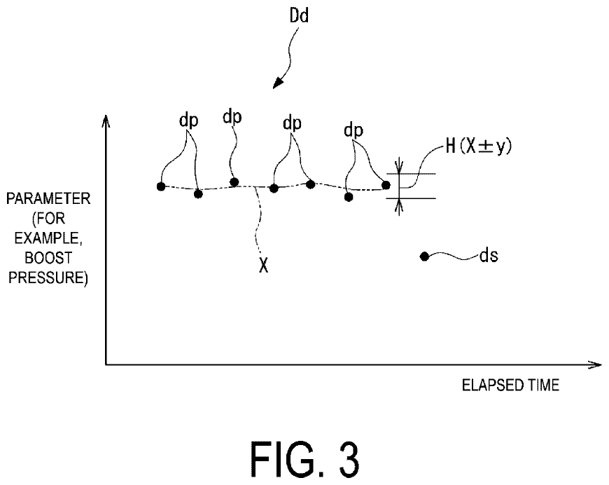

FIG. 3 is a diagram illustrating an example of time-series data obtained from a plurality of detection values d.

The aggregation unit 25 arranges the plurality of detection values d in chronological order based on the time information associated with each of the plurality of detection values d, and generates time-series data (not illustrated) of the detection values d for each of the plurality of parameters. Thus, time-series data indicating a change in the boost pressure of the engine 21 in a time-series order is obtained. At this time, through the filtering process of the filtering unit 24 as described above, the time-series data indicating the state change of the engine 21 when the operating state of the engine 21 is stable in the same operation state is obtained.

The aggregation unit 25 performs aggregation processing on the obtained time-series data at a time interval longer than the time interval at which the plurality of detection values d are acquired. The aggregation unit 25 performs aggregation processing of an average value, a maximum value, and the like in units of one day, for example, on a plurality of detection values d acquired at one minute intervals, for example, thereby generating aggregated time-series data Dd as illustrated in FIG. 3. The time-series data Dd subjected to the aggregation processing has daily data dp including, for example, an average value, a maximum value, and the like of a plurality of detection values d in units of one day. Accordingly, even when the state of the engine 21 is rapidly changed in a short time, the aggregation processing is performed, and thus, it is possible to prevent subsequent processing from being affected by the rapid change.

The transmission unit 26 transmits the time-series data Dd aggregated by the aggregation unit 25. The transmission unit 26 transmits the data to the diagnosis system body 3 via a network (not illustrated) such as a public wireless telephone network or the Internet. The transmission of data from the transmission unit 26 may be performed sequentially each time each detection value is detected, or may be performed at a preset time interval (for example, every hour, every day, or the like).

(Configuration Example of Diagnosis System Body 3) The diagnosis system body 3 is a computer device such as a personal computer or a server. The diagnosis system body 3 can be configured using a computer such as a central processing unit (CPU) or a microcomputer, and hardware such as peripheral circuits or peripheral devices of the computer. The diagnosis system body 3 includes a data reception unit 31, a diagnosis unit 34, and a result output unit 35 as functional configurations configured of a combination of hardware and software such as a program executed by a computer. The diagnosis system body 3 diagnoses the state of the engine 21 in accordance with the operating state of the engine 21 included in the vehicle 2.

The diagnosis system body 3 may be configured using a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

In the present embodiment, the diagnosis system body 3 is provided in a management center or the like of the vehicle 2, which is provided remotely from the vehicle 2 and the user terminal 4.

The data reception unit 31 receives data transmitted from the transmission unit 26 of the vehicle 2 via the network. The data reception unit 31 transfers the received data to the diagnosis unit 34.

The diagnosis unit 34 diagnoses the state of the engine 21 based on the received data. The diagnosis unit 34 diagnoses the state of the engine 21 based on the time-series data Dd related to the plurality of parameters aggregated by the aggregation unit 25. That is, the diagnosis unit 34 diagnoses the state of the engine 21 based on the data related to the plurality of parameters obtained by performing the aggregation processing on the detection values d acquired in the operation state of the engine 21 satisfying the preset condition. The diagnosis unit 34 functionally includes a range setting unit 37, a determination unit 38, and a timing estimation unit 39.

The range setting unit 37 calculates a moving average of a plurality of detection values d that are acquired at time intervals in this manner and have undergone the aggregation processing. In the present embodiment, the range setting unit 37 calculates a moving average X for the daily data dp of the time-series data Dd for a plurality of days. The plurality of pieces of daily data dp of the time-series data Dd for which the moving average X is to be calculated are appropriately set to, for example, the latest five days, ten days, or the like.

Further, the range setting unit 37 sets a range H including a preset allowable range (for example, ±y) with reference to the calculated moving average X.

The determination unit 38 determines whether or not each parameter is normal based on whether or not the latest detection value ds in the time-series data Dd of each parameter acquired by the data acquisition unit 23 is outside the range H (moving average X±y) set by the range setting unit 37. When the latest detection value ds is outside the range H, the determination unit 38 determines that the parameter is abnormal (hereinafter, this case may be referred to as an accidental abnormality). When the latest detection value ds is within the range H, the determination unit 38 determines that the parameter is normal.

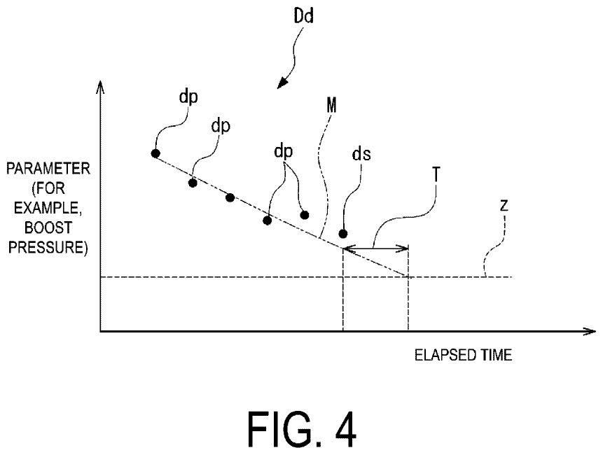

FIG. 4 is a diagram illustrating an example of a prediction model of a parameter that leads to a failure due to deterioration or wear over time.

The timing estimation unit 39 estimates the occurrence timing of a failure for a part related to a parameter that leads to a failure due to deterioration or wear over time. As illustrated in FIG. 4, the timing estimation unit 39 generates a prediction model M indicating a change over time in the daily data dp of the parameter from the plurality of daily data dp of the time-series data Dd obtained based on the plurality of detection values d acquired at time intervals. The timing estimation unit 39 generates the prediction model M by an approximation expression acquired from the plurality of pieces of daily data dp of the time-series data Dd obtained based on a plurality of detection values d acquired at time intervals. Here, as the plurality of pieces of daily data dp of the time-series data Dd used to acquire the approximation expression, for example, a moving average X of the pieces of daily data dp for the most recent several days (for example, five days) may be used. Further, as the plurality of pieces of daily data dp acquired at time intervals, which are used to acquire the approximation expression, all pieces of daily data dp from the time the engine 21 started to be used or since the last time a failure of the same part was dealt with may be used.

The timing estimation unit 39 calculates a time to reach the threshold value z at which a failure is assumed to occur at a portion related to the parameter using the prediction model M generated in this manner, and predicts a difference from the diagnosis time as a period T. The timing estimation unit 39 estimates an occurrence timing of the failure based on the calculated period T until the threshold value z is reached.

The determination unit 38 determines whether or not each parameter is normal based on whether or not the period T estimated by the timing estimation unit 39 is within a preset timing range. When the estimated period T is within a preset timing range (for example, within 50 days or within 30 days), the determination unit 38 determines that the parameter is abnormal due to the influence of deterioration (hereinafter, this case may be referred to as deterioration abnormality). When the estimated period T is not within the preset timing range, the determination unit 38 determines that there is no influence of deterioration and the parameter is normal.

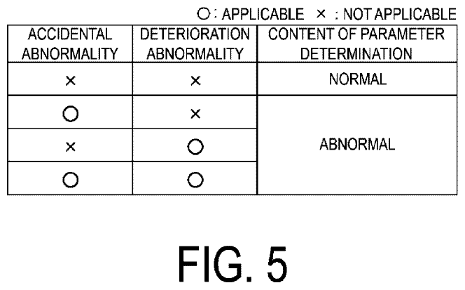

FIG. 5 is a diagram illustrating an example of abnormality determination content of each parameter based on the presence or absence of an accidental abnormality and the presence or absence of a deterioration abnormality.

As illustrated in FIG. 5, when both the accidental abnormality in which the latest detection value ds is outside the range H and the deterioration abnormality in which the estimated period T is within the preset timing range do not occur in each of the plurality of parameters, the determination unit 38 determines that the parameter is normal. When at least one of the accidental abnormality in which the latest detection value ds is out of the range H and the deterioration abnormality in which the estimated period T is within the preset timing range occurs in each of the plurality of parameters, the determination unit 38 determines that the parameter is abnormal.

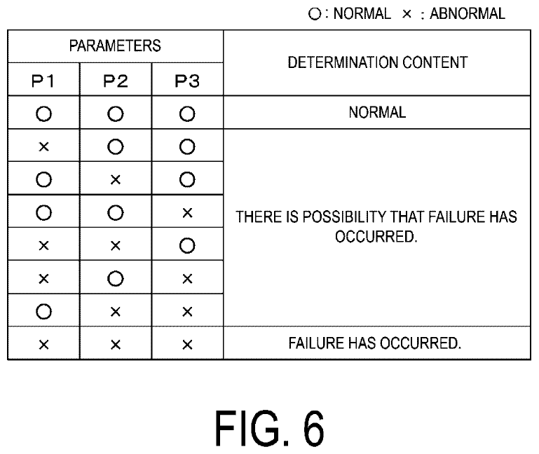

FIG. 6 is a diagram illustrating an example of the determination of diagnosis when a failure is determined by using a specific parameter or a combination of a plurality of parameters as a criterion for determining the occurrence of a failure.

Here, a plurality of types of parameters may be included as criteria for determining the occurrence of the specific failure. As illustrated in FIG. 6, for example, three types of parameters P1, P2, and P3 may be included as criteria for determining the occurrence of a specific failure. In such a case, the determination unit 38 determines that a failure has occurred in the engine 21 when all the parameters among the plurality of types of parameters are not normal, that is, all the parameters are abnormal. When only some of the plurality of types of parameters are not normal, that is, when some of the parameters are abnormal, it is determined that there is a possibility of failure of the engine 21. When all of the plurality of types of parameters P1, P2, and P3 are normal, the determination unit 38 determines that the engine 21 is normal. When only one specific parameter is used as a criterion for determining the occurrence of a specific failure, the occurrence of the specific failure may be determined from only the one parameter.

The result output unit 35 illustrated in FIG. 1 outputs the diagnosis result of the diagnosis unit 34 to the user terminal 4 via a network (not illustrated). For example, when the diagnosis unit 34 determines that the engine 21 has failed, the result output unit 35 transmits a message or the like indicating that the engine 21 has failed to the user terminal 4. When the diagnosis unit 34 determines that there is a possibility that the engine 21 has failed, the result output unit 35 transmits a message or the like indicating that there is a possibility that the engine 21 has failed to the user terminal 4. For example, when the occurrence timing of a failure due to deterioration or wear of the engine 21 is estimated for a parameter determined to be abnormal by the diagnosis unit 34, the result output unit 35 transmits a message or the like regarding the timing to the user terminal 4. In this case, at a time when the estimated occurrence timing of the failure is, for example, within 50 days or within 30 days, the result output unit 35 may transmit a message or the like regarding the occurrence timing of the failure to the user terminal 4. When the diagnosis unit 34 determines that the engine 21 is normal, the result output unit 35 may transmit a message or the like indicating that the engine 21 is normal to the user terminal 4.

### (Configuration Example of User Terminal 4)

The user terminal 4 can be configured using a computer such as a microcomputer or a central processing unit (CPU), and hardware such as peripheral circuits and peripheral devices of a computer. The user terminal 4 is, for example, a personal computer, a tablet terminal, a smartphone, or the like. The user terminal 4 includes a result reception unit 41 and a display unit 42 as functional configurations configured of a combination of hardware and software such as a program executed by the computer.

The result reception unit 41 receives a message or the like related to the diagnosis result in the diagnosis unit 34 from the result output unit 35 via the network. The result reception unit 41 transfers data such as the received message to the display unit 42. The display unit 42 displays a message or the like related to the diagnosis result in the diagnosis unit 34 based on the transferred data. Accordingly, a person in charge who has confirmed the message or the like displayed on the display unit 42 can perform a measure as necessary on the part of the vehicle 2 indicated by the displayed message.

### (Operation Example of Engine Diagnosis System 1)

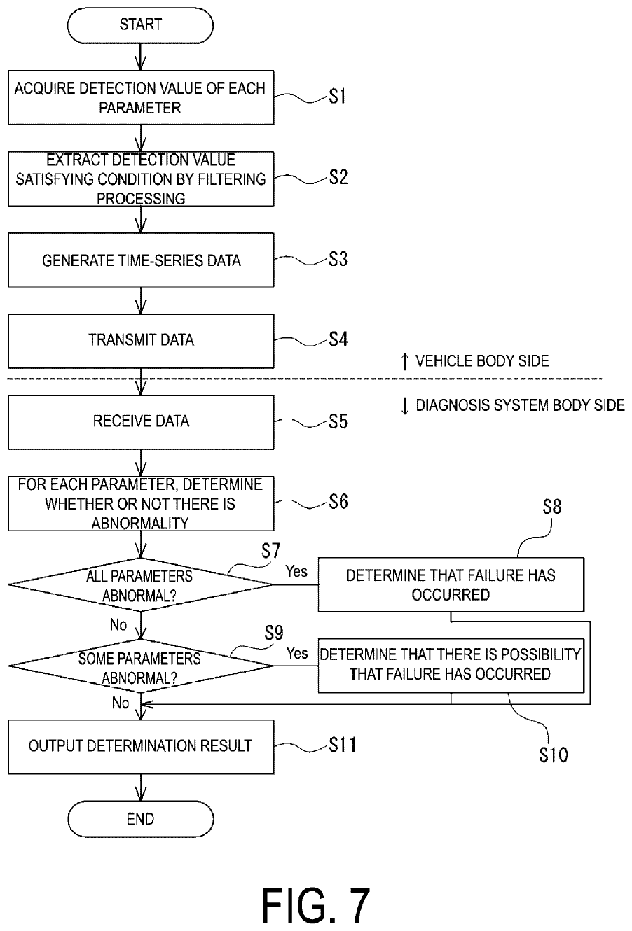

An operation example of the engine diagnosis system 1 illustrated in FIG. 1 will be described with reference to FIG. 7. The process illustrated in FIG. 7 is repeatedly executed at a predetermined cycle. When the processing illustrated in FIG. 7 is started, the data acquisition unit 23 on the vehicle 2 side acquires the detection values d related to the plurality of types of parameters indicating the operating state of the engine 21 detected by the detection unit 22. The data acquisition unit 23 acquires the detection values d of the plurality of types of parameters a plurality of times at time intervals (step S1).

Next, the filtering unit 24 extracts the detection values d acquired in the operation state of the engine 21 satisfying a preset condition among the plurality of acquired detection values d (step S2).

Specifically, first, the filtering unit 24 extracts only the detection values d in which the rotation speed and the torque of the engine 21 are within a preset region A as illustrated in FIG. 2. When the plurality of regions A are set, processing of extracting the detection values d in the region A is performed in parallel in each of the plurality of regions A. At this time, the region A in which the number of the detection values d is the largest may be selected from the plurality of regions A, and the plurality of detection values d in the selected region A may be extracted. The filtering unit 24 extracts, from the plurality of detection values d extracted from the region A, the detection values d acquired when the time change amount of the rotation speed and the time change amount of the torque of the engine 21 when the detection values d are detected are within the preset reference value.

Further, the filtering unit 24 extracts, from the plurality of extracted detection values d, the detection values d acquired when the temperature of the cooling water of the engine 21 at the time of detection of the detection values d is equal to or higher than the preset reference temperature.

The filtering unit 24 classifies the detection values d based on the operation mode of the engine 21 when the extracted detection values d are detected. For example, the operation mode in which the occurrence of a failure is to be diagnosed is selected from among the normal operation mode, the highland mode, the low-temperature mode, and the forced regeneration mode.

The order of the processing of extracting the detection value d in the filtering unit 24 can be changed appropriately. Further, the conditions for extracting the detection values d can be selected and changed appropriately.

Next, the aggregation unit 25 arranges the plurality of detection values d in chronological order based on the time information associated with each of the plurality of detection values d, and generates the time-series data of the detection values d for each of the plurality of parameters (step S3). Further, the aggregation unit 25 performs aggregation processing of the obtained time-series data, for example, an average value or a maximum value in a unit of one day, and obtains aggregated time-series data Dd.

After the aggregation processing, the transmission unit 26 transmits the aggregated time-series data Dd of each of the plurality of generated parameters to the diagnosis system body 3 (step S4).

The data reception unit 31 of the diagnosis system body 3 receives the time-series data Dd, which is transmitted from the transmission unit 26, as the data related to the plurality of types of parameters indicating the operating state of the engine 21 (step S5).

Next, the diagnosis unit 34 determines the presence or absence of an accidental abnormality and a deterioration abnormality for each of the plurality of types of parameters received (step S6).

For this, the range setting unit 37 calculates a moving average X of the plurality of pieces of daily data dp included in the acquired time-series data Dd. In the present embodiment, the range setting unit 37 calculates the moving average X of the daily data dp for a plurality of days obtained from the plurality of detection values d acquired at time intervals in the time-series data Dd. Further, the range setting unit 37 sets a range H including a preset allowable range (for example, ±y) with reference to the calculated moving average X.

Subsequently, the determination unit 38 determines whether or not the latest detection value ds included in the time-series data Dd acquired by the data acquisition unit 23 is outside the range H (moving average X±y) set by the range setting unit 37. When the latest detection value ds included in the time-series data Dd is outside the range H, the determination unit 38 determines that an accidental abnormality has occurred in the parameter. When the latest detection value ds is within the range H, the determination unit 38 determines that the parameter is normal.

Further, the timing estimation unit 39 generates the prediction model M indicating the change over time of the parameter based on the plurality of pieces of daily data dp included in the time-series data Dd acquired at time intervals. The timing estimation unit 39 calculates a time to reach the threshold value z at which a failure is assumed to occur at a portion related to the parameter using the generated prediction model M, and predicts a difference from the diagnosis time as the period T. The timing estimation unit 39 estimates the occurrence timing of the failure based on the calculated period T until the threshold value z is reached.

When the period T estimated by the timing estimation unit 39 is within a preset timing range (for example, within 50 days or within 30 days), the determination unit 38 determines that a deterioration abnormality has occurred in the parameter due to the influence of deterioration. When the estimated period T is not within the preset timing range, the determination unit 38 determines that there is no influence of deterioration and the parameter is normal.

As illustrated in FIG. 5, when both the accidental abnormality in which the latest detection value ds is outside the range H and the deterioration abnormality in which the estimated period T is within the preset timing range do not occur in each of the plurality of parameters, the determination unit 38 determines that the parameter is normal. When at least one of the accidental abnormality in which the latest detection value ds is out of the range H and the deterioration abnormality in which the estimated period T is within the preset timing range occurs in each of the plurality of parameters, the determination unit 38 determines that the parameter is abnormal.

Next, based on a determination result of the presence or absence of abnormality in each parameter in step S6, the determination unit 38 determines whether or not all the parameters are abnormal (step S7). When only one specific parameter is used as a criterion for determining the occurrence of a specific failure, the determination unit 38 determines whether the one parameter is abnormal.

As a result of the determination in step S7, when it is determined that all the parameters are abnormal (step S7: Yes), the determination unit 38 determines that a failure has occurred in the engine 21 (step S8).

As a result of the determination in step S7, when it is not determined that all the parameters are abnormal (step S7: No), the process proceeds to step S9.

In step S9, the determination unit 38 determines whether or not some of the plurality of types of parameters are determined to be abnormal.

As a result of the determination in step S9, when it is determined that some parameters are abnormal (step S9: Yes), the determination unit 38 determines that there is a possibility that a failure has occurred in the engine 21 (step S10).

As a result of the determination in step S7, when it is determined that some parameters are not determined to be abnormal, that is, all parameters are determined to be normal (step S9: No), the determination unit 38 determines that the engine 21 is normal.

Thereafter, the result output unit 35 outputs a determination result from the determination unit 38 to the user terminal 4 (step S11). Accordingly, the user terminal 4 can ascertain the state of the vehicle 2 without actually confirming the vehicle.

### Actions and Effects

According to the present embodiment, it is possible to more appropriately diagnose a failure in each vehicle 2.

### Variation of Embodiment

In the above embodiment, whether or not the parameter is normal is determined based on whether or not the latest detection value is outside the range based on the moving average of the daily data obtained from the plurality of detection values, but the present invention is not limited thereto.

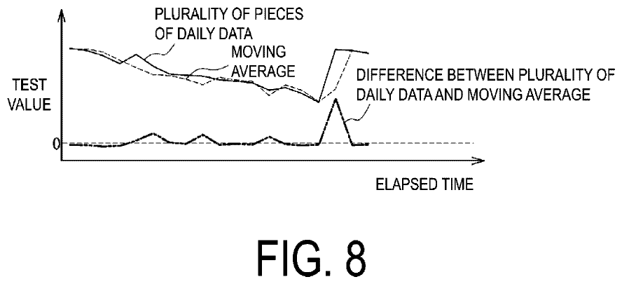

FIG. 8 is a diagram illustrating an example of data of a difference between time-series data aggregated into daily data and a moving average of the time-series data in the engine diagnosis system according to the variation of the embodiment.

For example, the diagnosis unit 34 may determine whether or not the parameter is normal based on a variation in data of a difference between daily data obtained from the plurality of detection values acquired at time intervals and the moving average of the plurality of daily data as illustrated in FIG. 8. In this case, the diagnosis unit 34 calculates an abnormality degree a (x) in data of a difference between the plurality of pieces of daily data xi and the moving average of the plurality of pieces of daily data xi by the following Equation (1).

$$[ Math . 1 ]$$

$$a ( x ) = {( \frac{x - \dot{x}}{s} )}^{2} \qquad ( 1 )$$

Here, in the above equation (1), an average of data of differences between the plurality of detection values and the moving average of the plurality of detection values is expressed by the following equation (2). Further, in the above equation 1, an invariant variance s2 of data of a difference between the plurality of pieces of daily data and the moving average of the plurality of pieces of daily data is expressed by the following equation (3).

$$[ Math . 2 ]$$

$$\overline{x} = \frac{1}{n} {\sum }_{i = 1}^{n} {x}_{i} \qquad ( 2 )$$

$$[ Math . 3 ]$$

$${s}^{2} = \frac{1}{n - 1} {\sum }_{i = 1}^{n} {( {x}_{i} - \overline{x} )}^{2} \qquad ( 3 )$$

For example, the diagnosis unit 34 may determine that the parameter is abnormal when the difference between the plurality of pieces of daily data and the moving average of the plurality of pieces of daily data is negative and the calculated abnormality degree is equal to or greater than a preset threshold value.

Although the embodiments of the disclosure have been described above with reference to the drawings, a specific configuration is not limited to the above-described embodiments and also includes design changes and the like that do not depart from the gist of the disclosure.

For example, in the engine diagnosis system 1 according to the above-described embodiment, the diagnosis system body 3 is provided separately from the vehicle 2 and the user terminal 4, but the present disclosure is not limited thereto. For example, the diagnosis system body 3 may be included in the vehicle 2 or may be provided in the user terminal 4.

For example, in the engine diagnosis system 1 according to the above-described embodiment, the moving average is calculated and the prediction model is generated based on the time-series data Dd aggregated at a time interval longer than the time interval at which the plurality of detection values d are acquired, for example, every day, from the plurality of detection values d acquired at time intervals, but the present disclosure is not limited thereto. The calculation of the moving average, the generation of the prediction model, and the like may be directly performed from the plurality of detection values d acquired at time intervals.

Further, a part or an entirety of the program executed by the computer in the above-described embodiments can be distributed via a computer-readable recording medium or a communication line.

### INDUSTRIAL APPLICABILITY

According to the engine diagnosis system and the engine diagnosis method described above, it is possible to more appropriately diagnose a failure in each vehicle.

### REFERENCE SIGNS LIST

1. Engine diagnosis system, 2. Vehicle, 21. Engine, 32. Data acquisition unit, 33. Filtering unit, 34. Diagnosis unit, 35. Result output unit, 37. Range setting unit, 38. Determination unit, 39. Timing estimation unit, H. Range, M. Prediction model

1. An engine diagnosis system for diagnosing a state of an engine included in a vehicle in accordance with an operating state of the engine, the engine diagnosis system comprising:
a data acquisition unit configured to acquire a detection value related to a parameter indicating the operating state of the engine a plurality of times at time intervals;
a diagnosis unit configured to diagnose the state of the engine based on the detection value acquired by the data acquisition unit; and
a result output unit configured to output a diagnosis result in the diagnosis unit, wherein the diagnosis unit includes a determination unit configured to determine whether or not a failure has occurred in the engine based on a moving average of a plurality of the detection values acquired at time intervals and the latest detection value acquired by the data acquisition unit.

2. The engine diagnosis system according to claim 1, wherein
the diagnosis unit includes a range setting unit configured to set a range with reference to the moving average of the plurality of detection values acquired at time intervals, and
the determination unit determines whether or not the parameter is normal based on whether or not the latest detection value acquired by the data acquisition unit is outside the range.

3. The engine diagnosis system according to claim 1, wherein the diagnosis unit determines whether or not the parameter is normal based on a variation in a difference between the plurality of detection values acquired at time intervals and the moving average of the plurality of detection values.

4. The engine diagnosis system according to claim 1, further comprising:
a timing estimation unit configured to generate a prediction model indicating a change over time in the detection value of the parameter from an approximation expression acquired based on the plurality of detection values acquired at time intervals, and estimate an occurrence timing of a failure in a part related to the parameter based on the latest detection value acquired by the data acquisition unit and the prediction model, wherein
the determination unit determines whether or not the parameter is normal based on whether or not the failure occurrence timing estimated by the timing estimation unit is within a preset timing range.

5. The engine diagnosis system according to claim 1, wherein
the data acquisition unit acquires the detection values related to a plurality of types of the parameters indicating the operating state of the engine, and
the determination unit determines that a failure has occurred in the engine when it is determined that all of the plurality of types of parameters are not normal.

6. The engine diagnosis system according to claim 5, wherein the determination unit determines that there is a possibility of failure of the engine when it is determined that some of the plurality of types of parameters are not normal.

7. An engine diagnosis method for diagnosing a state of an engine included in a vehicle in accordance with an operating state of the engine, the engine diagnosis method comprising:
acquiring a detection value related to a parameter indicating the operating state of the engine a plurality of times at time intervals;
diagnosing the state of the engine based on the acquired detection value; and
outputting a diagnosis result for the state of the engine, wherein
the diagnosing of the state of the engine includes determining whether or not a failure has occurred in the engine based on a moving average of a plurality of the detection values acquired at time intervals and the latest detection value acquired by the data acquisition unit.

8. The engine diagnosis system according to claim 2, further comprising:
a timing estimation unit configured to generate a prediction model indicating a change over time in the detection value of the parameter from an approximation expression acquired based on the plurality of detection values acquired at time intervals, and estimate an occurrence timing of a failure in a part related to the parameter based on the latest detection value acquired by the data acquisition unit and the prediction model, wherein
the determination unit determines whether or not the parameter is normal based on whether or not the failure occurrence timing estimated by the timing estimation unit is within a preset timing range.

9. The engine diagnosis system according to claim 2, wherein
the data acquisition unit acquires the detection values related to a plurality of types of the parameters indicating the operating state of the engine, and
the determination unit determines that a failure has occurred in the engine when it is determined that all of the plurality of types of parameters are not normal.

10. The engine diagnosis system according to claim 9, wherein the determination unit determines that there is a possibility of failure of the engine when it is determined that some of the plurality of types of parameters are not normal.
